(19) United States
(12) Patent Application Publication
(10) Pub. No.: US 2020/0024006 A1
(43) Pub. Date: Jan. 23, 2020

(54) SYSTEM FOR SPACE PROPULSION AND SPACE LOITERING (ABOVE-STRATOSPHERE AIR LOITERING)

(71) Applicants: KINGO UEUCHI, Kakogawa City, Hyogo (JP); GRACEMARIE WORLD CORPORATION, Kakogawa City, Hyogo (JP)

(72) Inventor: Ueuchi KINGO, Kakogawa City, Hyogo (JP)

(21) Appl. No.: 15/519,448

(22) PCT Filed: Oct. 17, 2015
(86) PCT No.: PCT/JP2015/079386

§ 371 Date: Apr. 14, 2017

(30) Foreign Application Priority Data
Oct. 17, 2014 (JP) 2014-213248

(51) Int. Cl. B64G 1/40

(52) U.S. Cl. CPC B64G 1/409

(57) ABSTRACT

To achieve a special spacecraft (flying aircraft) having propulsion efficiency that is several times (several orders of magnitude) greater than that of a solar sailcraft and the like, and requires practically no disposable (in space) and expensive rocket fuel or the like, and also to achieve a stratospheric flying aircraft capable of loitering. The present invention applies the difference in pressure (internal pressure) acting on wall surfaces (inner walls) or the like at both ends of a propulsion module body (aerial body) in space where there is no atmosphere or the like. Specifically, the present invention adopts a propulsion method as set forth in the claims.

### TECHNICAL FIELD

This invention is mainly connected with propulsion technology for (aero)space vehicles etc.

### BACKGROUND

First of all, it is said that a (spaceship) body of the closed system has never moved in accordance with the conservation law of momentum until now, unless something (propellant) is released outside the system . . .

However, in consideration of the closed [ . . . ] system, it could not apply the momentum conservation law, including even a flowable substance inside the same system.

Because it would be able to be easily judged when rightly understood Pascal's principle is defined as:

When there is an increase in pressure at any point in a confined fluid, there is an equal increase at every other point in the container.

(and/or)

In a fluid at rest in a closed container, a pressure change in one part is transmitted without loss to every portion of the fluid and to the walls of the container.

In brief, just the thing that the Pascal's law (which may well apply the momentum conservation law only in the above container) could be applied is limited to a state of “rest” in fluid statics (not fluid dynamics).

So, it must move necessarily (not remain at rest) for an object (with a hollow body) of the closed [fluid] system in case of being able to cause aptly some pressure difference according to mainly Bernoulli's Principle, using a fluid moving body (flowable substance) in the same container.
Note: Please pay attention to that Bernoulli's principle is not always based on the law of momentum conservation, even though it corresponds to the law of the conservation of energy.

[The Supplement]

As for the definition of the closed system related to the conservation law of momentum, it is basically classified as follows.
The momentum conservation law can be applied in the closed non-fluid system.
The above important law can not be applied in the closed fluid system at all.

In a closed system (one that does not exchange any matter with its surroundings and is not acted on by external forces and does not allow certain types of transfers in or out of the system),

the total momentum is constant. (the momentum conservation law)

However, just inside a closed fluid system that does allow certain types of transfers (such as transfer of mass and/or matter) in the closed system of a hollow type, the total momentum is “variable”. (the momentum non-conservation law)

So, Pascal's (first) law is defined as

A change in pressure at any point in an enclosed fluid at rest is transmitted undiminished to all points in the fluid.

And Pascal's second law (or King O's principle) may be defined as

A change in pressure at a point in an enclosed fluid not at rest is transmitted increasing (and/or) decreasing to any other point(s) in the fluid.

Therefore, the hollow body (as a spaceship body) in the closed fluid system must always move forward (or backward) in case of being able to cause pressure difference by the fluid at both ends (etc) of its body, just considering Bernoulli's principle that is not necessarily based on the law of momentum conservation and that corresponds to the law of the conservation of energy yet.

[Basic Points of Attention of Newton's Laws of Motion]

The established first law is . . .

Newton's first law states that every object will remain at rest or in uniform motion in a straight line unless compelled to change its state by the action of an external force.

The revision of the above law should be . . .

Newton's first law states that every object (except one with a hollow body included flowable substances in it) will remain at rest or in uniform motion in a straight line unless compelled to change its state by the action of an external force.

[Basic Points of Attention of Thermodynamics]

The fixed first law of thermodynamics may be principally stated as follows:

The increase in internal energy of a closed system is equal to total of the energy added to the system . . .

But, it should be revised (added) more precisely thus,
The increase in internal energy of a closed (non-fluid) system is equal to total of the energy added (from its surroundings) to the system . . . {Non-equilibrium Thermodynamics}.

As for the following space propulsion devices (not a perpetual-motion machine) of the closed fluid system, no matter how much frictional heat (frictional force) has been gathered during the engine operation of the apparatus(es), they could not have affected so much the moving force (motility) produced by the pressure difference . . .

[The Consequence]

F=(P1−P2)Ae

F: Thrust force by (internal) pressure difference

P1: (Internal) Pressure pertaining to one direction (a forward direction)

P2: (Internal) Pressure pertaining to the opposite direction (a backward direction)

Ae: The area of the (inner) surface on the contact

Its formula is similar to “(pe−po)Ae” of “F=me Ve+(pe−po)Ae”as the existing rocket thrust'formula.

An object of hollow structure (that does allow certain types of transfers in its body) can be moved itself by an inner force (not an internal force in the action-reaction law) resulting from internal pressure difference without external forces (from the outside of the body).
Kind O's law of internal motion (by Kindo Ueuchi)

### SUMMARY

### Technical Problem

To achieve space propulsion unique technology more smartly (with no exhaust gas at all) without mainly spacecraft propulsion conventional methods by the existing rocket thrust (applied some reaction force) . . .

### Solution to Problem

It could be applied with propulsive force produced by (internal) pressure difference of an air pressure type (with uniquely air barrier devices) and/or a non-air pressure type (with an actual physical phenomenon called “completely inelastic collision” etc) involving either side (end) of a hollow body as a space propulsion module and the like.

### Advantageous Effect of Invention

Indeed, humankind would be able to really reach the [ . . . ] in interplanetary space flight with a manned spacecraft (with the lowest cost) of this (revolutionary) invention, moreover, even in interstellar travel . . .

### BRIEF DESCRIPTION OF DRAWINGS

FIG. 1 shows mainly names of parts for a space propulsion system device of a non-air pressure type.

FIG. 2 (omitting)

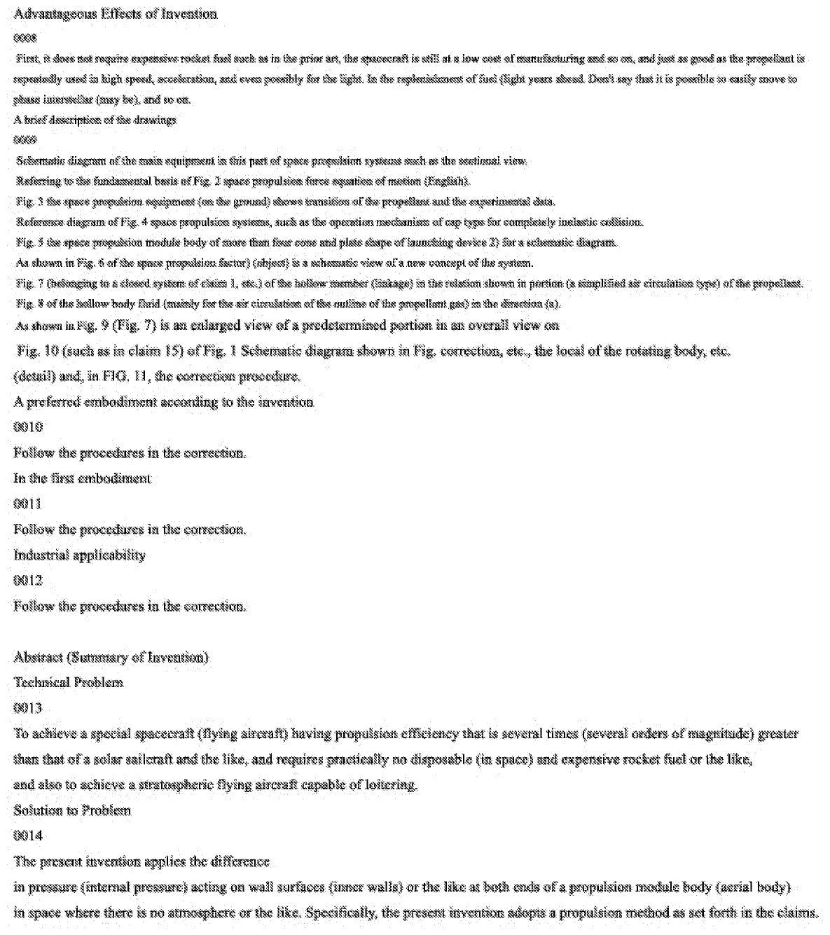

FIG. 3 indicated sequences (ordering operation) for the space propulsion system (of FIG. 1)

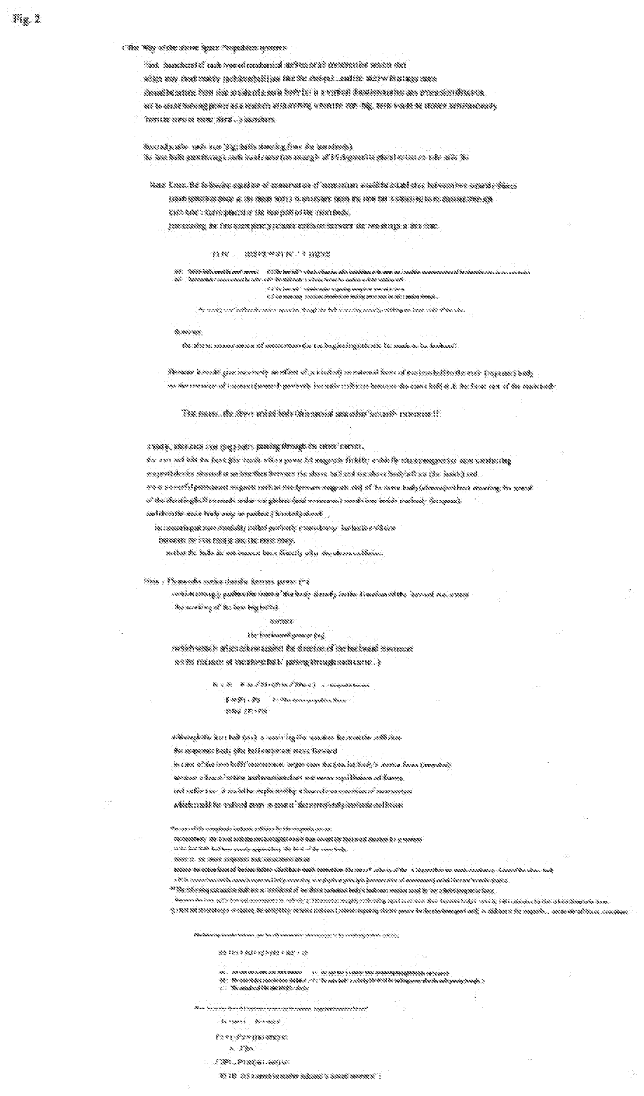

FIG. 4 shows each unique device with an automatic opening & shutting multi-cap type for the completely inelastic collision.

FIG. 5 gives application examples practically for the spacecraft propulsion system

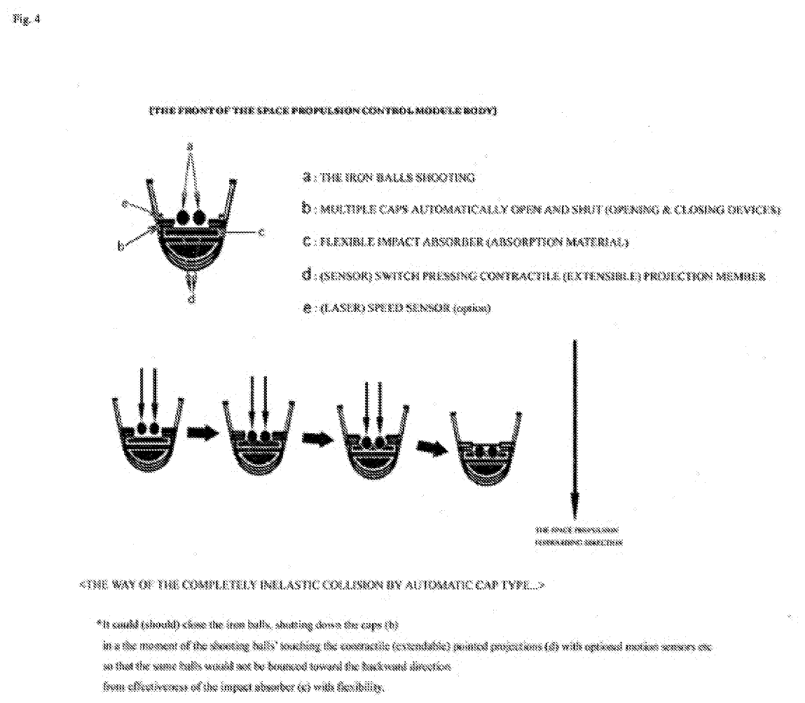

FIG. 6 (omitting)

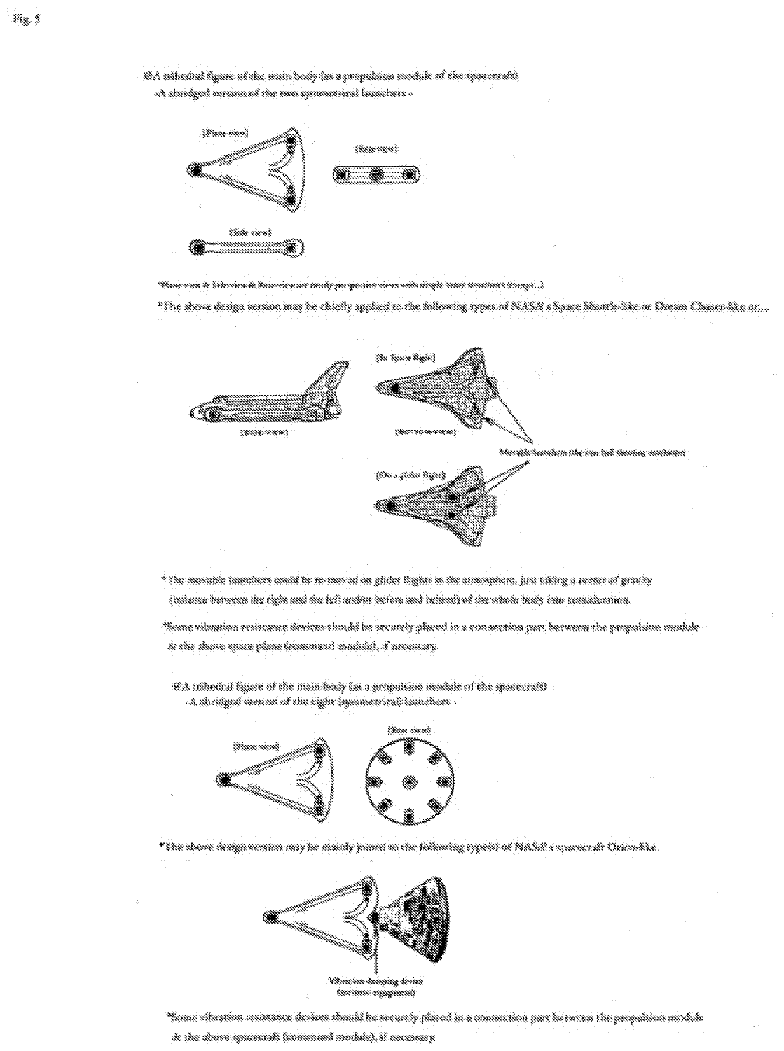

FIG. 7 shows mainly names of parts for a (aero)space propulsion system apparatus of an air pressure type.

FIG. 8 authenticates effectiveness of (aero)space propulsion by the air pressure difference with the above apparatus (of FIG. 7)

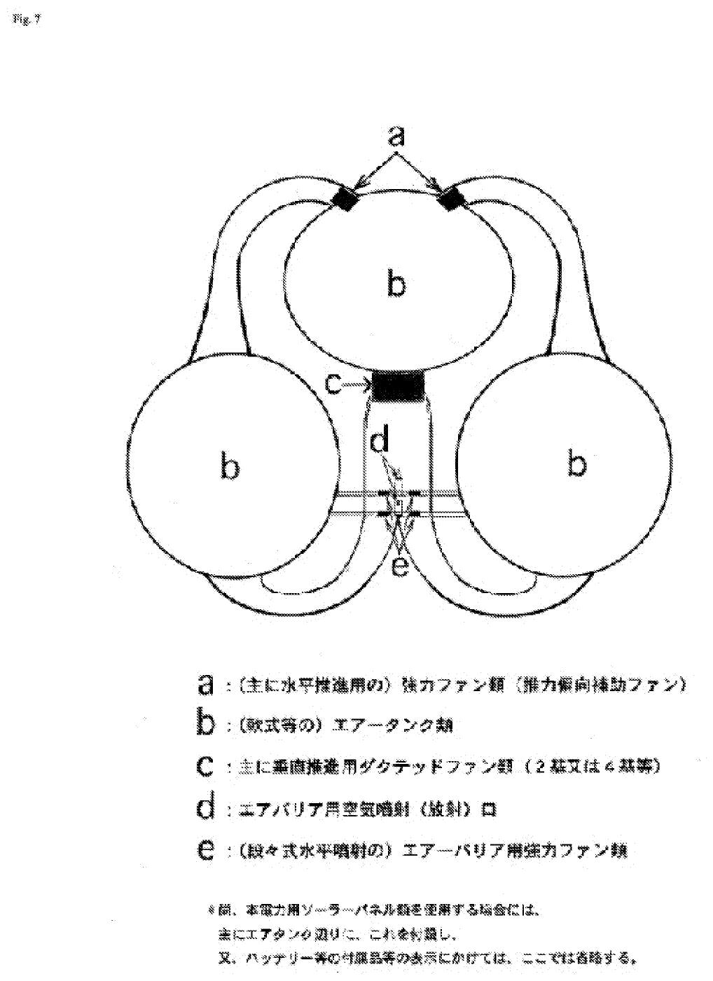

FIG. 9 shows uniquely a certain condition of the air barrier system devices.

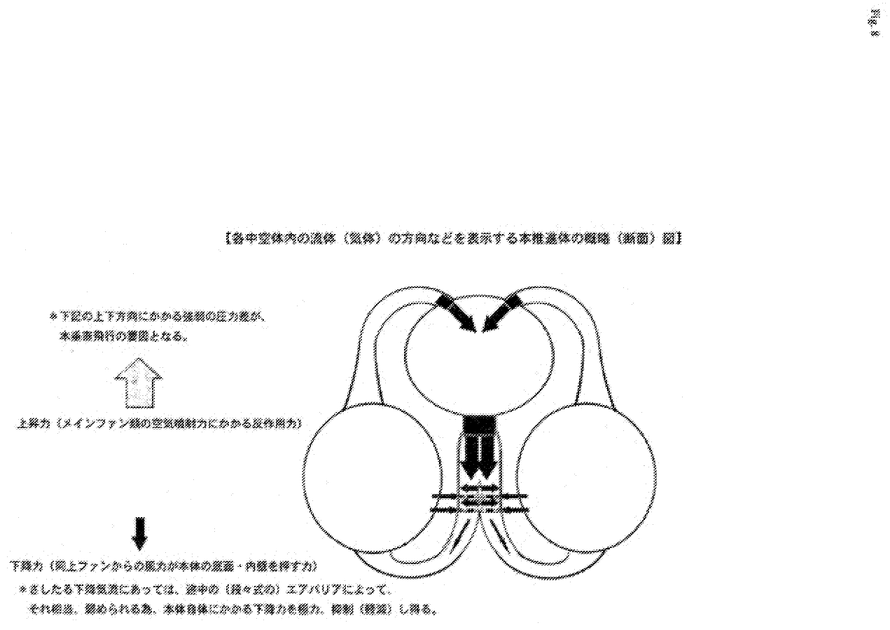

FIG. 10 indicates supplementary wind power rotor units for neutrally power distribution devices.

1-17 (canceled)

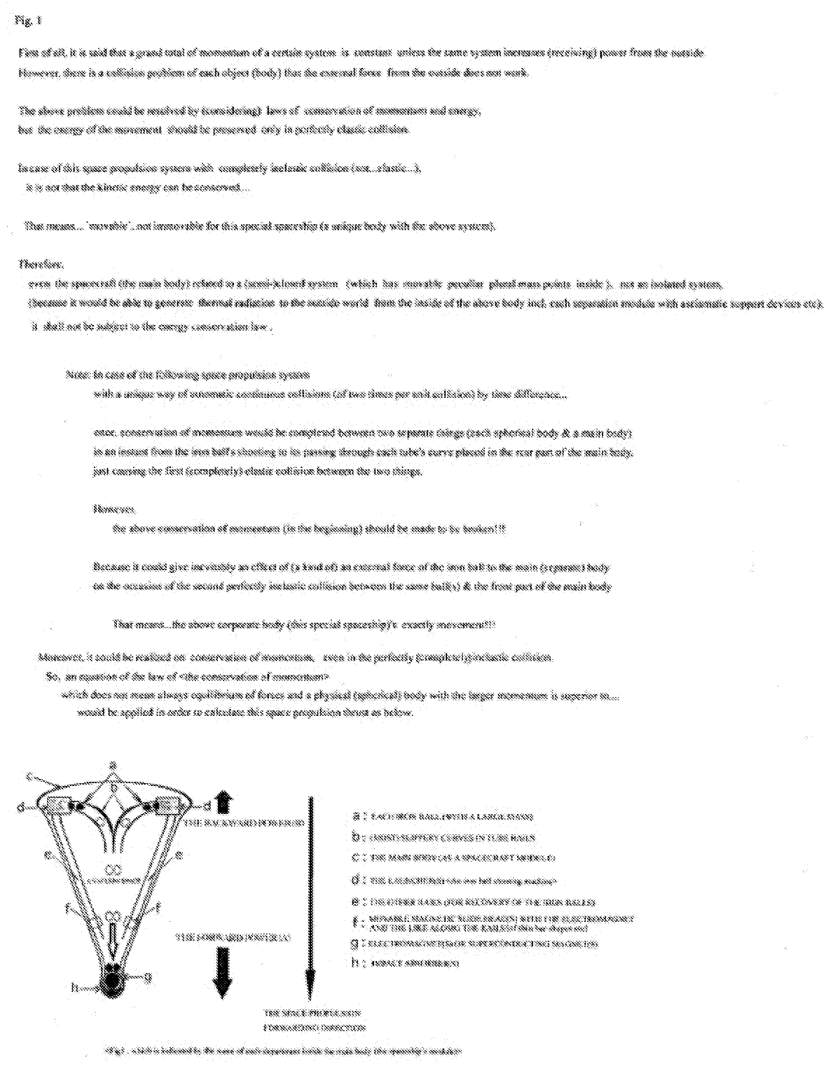

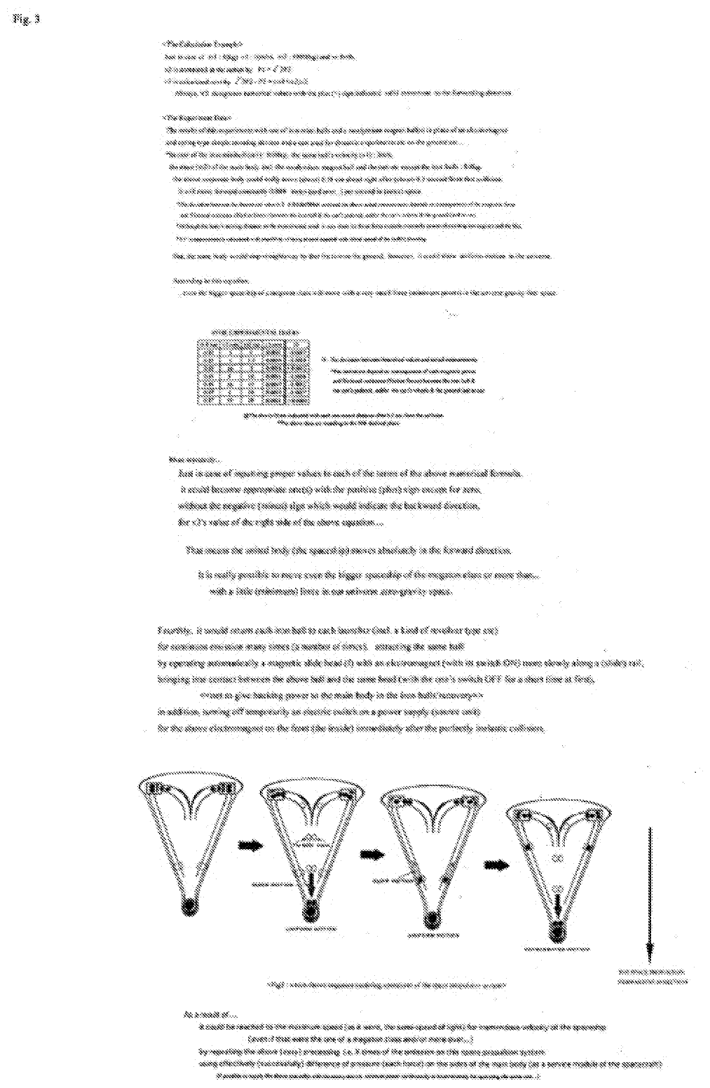

18: A spacecraft propulsion system and its related equipment (incl. the following iron balls return devices etc with a slower tempo in the operation) that could generate some power repeatedly from internal pressure difference (by uniquely relevant apparatus of a non-air pressure type), by varying each impact angle between an iron ball(s) shooting with the same ball launchers (incl. electromagnetic launchers which are able to shoot just synchronously, quickly, continuously) etc and (around) each inner wall of either side of a hollow body (as a space propulsion module), especially in case of completely (perfectly) inelastic collision by electromagnet apparatuses (see FIG. 1 & 3) and the like or by unique device with a kind of automatic opening & shutting multi-cap type (see FIG. 4) etc as to the one side, just after inserting a flowable substance(s) such as the above iron balls (with large mass) and so forth (not particles in the air in particular) inside the unique hollow body in the closed <fluid> system.

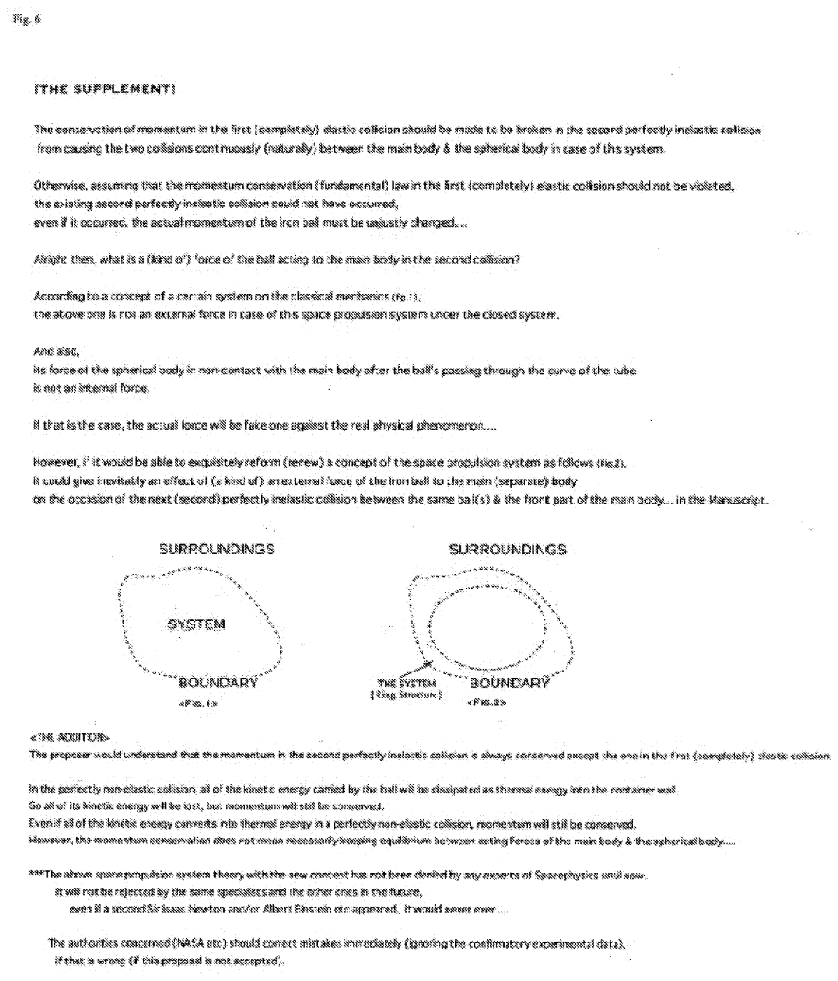

19: A spacecraft propulsion system and its associated equipment (incl. the following related devices etc) that could produce some force sustainably from internal pressure difference by mainly relevant apparatus of an air pressure type, by reducing wind pressure as to the one side of the hollow body with specific air-barrier devices (see FIG. 7, 8, 9) just after inserting a flowable substance(s) such as the particles in the air in particular for continuously air circulation inside the above hollow body (as a space propulsion module) in the closed <fluid> system.

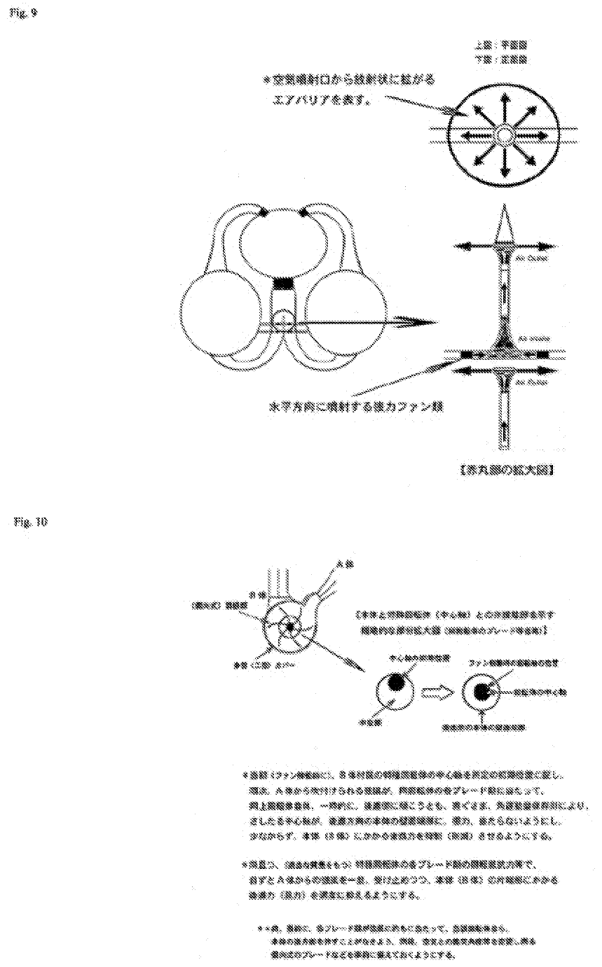

20: A space endurance flight system (staying in air above the stratosphere, in advance, utilizing chiefly the related apparatus of the above air pressure type in the claim 19) and the attached equipment including this space propulsion module'direction changing devices applied variation on the collision angle value and so on in addition to the shooting machine adopting a special technique of a magnetic projectile(s) called “Coil gun” and/or “Rail gun” and/or a sort of Mass driver: “Slingatron” etc as to each driving method by the shooting devices indicated with the main claim 18 and supplementary wind power rotor units (see FIG. 10) for neutrally power distribution devices.

21: A construction (and preservation) method and its relevant apparatus for unique (aero)space structure, applying propulsive forces of the space propulsion system indicated with the claim 18 & 19, etc to a counterweight (and the like) for a space elevator (for mainly the low earth orbit) and so on.
